(19) United States
(12) Patent Application Publication
(10) Pub. No.: US 2009/0280875 A1
(43) Pub. Date: Nov. 12, 2009

(54) MOBILE PHONE COVER AND MOBILE PHONE EMPLOYING THE SAME

(75) Inventor: JEN-YU LIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/277,236

(22) Filed: Nov. 24, 2008

(30) Foreign Application Priority Data
May 9, 2008 (CN) 200810301499.4

(51) Int. Cl. H04M 1/00

(52) U.S. Cl. 455/575.8

(57) ABSTRACT

A mobile phone cover includes a frame, which defines a screen area therein and a holder. The holder is partially fixed on the frame and extends towards the screen area.

### BACKGROUND

1. Technical Field

The disclosure relates to mobile phones and, specifically, to a mobile phone cover having a large screen area.

2. Description of Related Art

Various mobile phones have been developed based on the trend of miniaturization while having larger screens. Generally, a mobile phone cover includes a frame and a screen surrounded by the frame and used for receiving a liquid crystal display screen. The frame must be wide enough to receive a retainer used to fix a receiver on the frame, accommodate the electronics of the mobile phone, and a large screen.

Therefore, it is desirable to provide a mobile phone cover having a large screen area and a thin frame.

### BRIEF DESCRIPTION OF THE DRAWINGS

FIG. 1 is a perspective partial view of one embodiment of a mobile phone cover.

FIG. 2 is a cross-sectional view of the mobile phone taken along line IV-IV of FIG. 1.

FIG. 3 is a perspective view of the mobile phone cover of FIG. 1 having a lens and a electronic element installed therein.

FIG. 4 is an exploded perspective view of the mobile phone cover and the lens of FIG. 3.

### DETAILED DESCRIPTION OF EMBODIMENTS

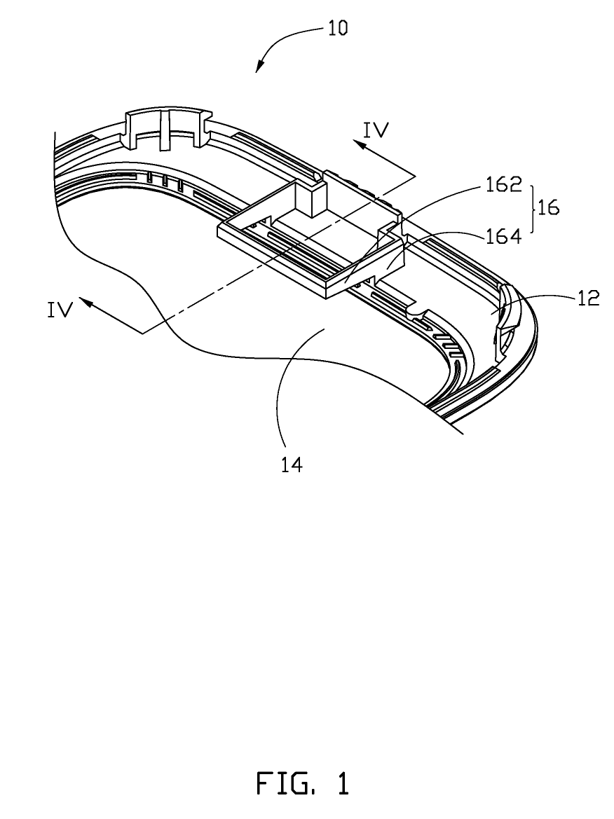

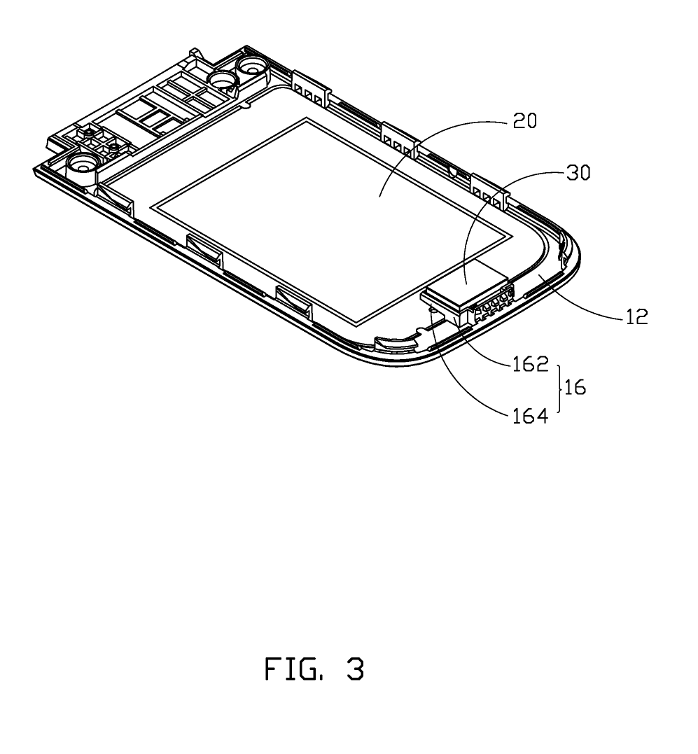

Referring to FIG. 1 and FIG. 3, a mobile phone cover used in a mobile phone comprises a frame 12, a screen area 14 surrounded by the frame 12, and a holder 16 used for fixing an electronic element 30, such as a receiver. The holder 16 is fixed on the frame 12 and extends over the screen area 14. The holder 16 includes a connecting part 162 fixed on an inner surface of the frame 12 and a free part 164 extending from the connecting part 162 over the screen area 14. The free part 164 makes up large portion of the holder 16. Since the connecting part 162 is fixed to the frame 12 and makes up a small portion of the holder, the portion of the frame 12 connected to the holder 16 can be designed very thin to obtain a large screen area 14. The holder 16 is sized to receive the electronic elements 30 securely in a tight fit, so that no fasteners, such as screws, are required.

In one embodiment, the holder 16 is integrally formed on the frame 12, requiring no independent production or additional installation, therefore, production costs are greatly reduced.

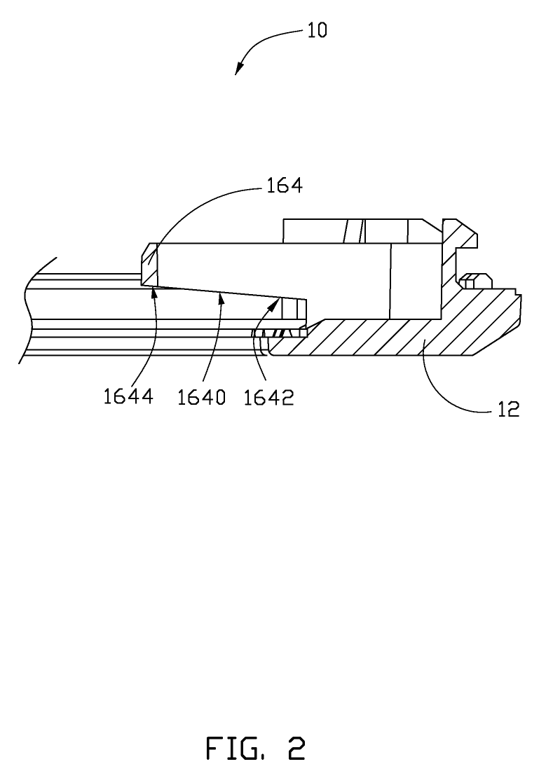

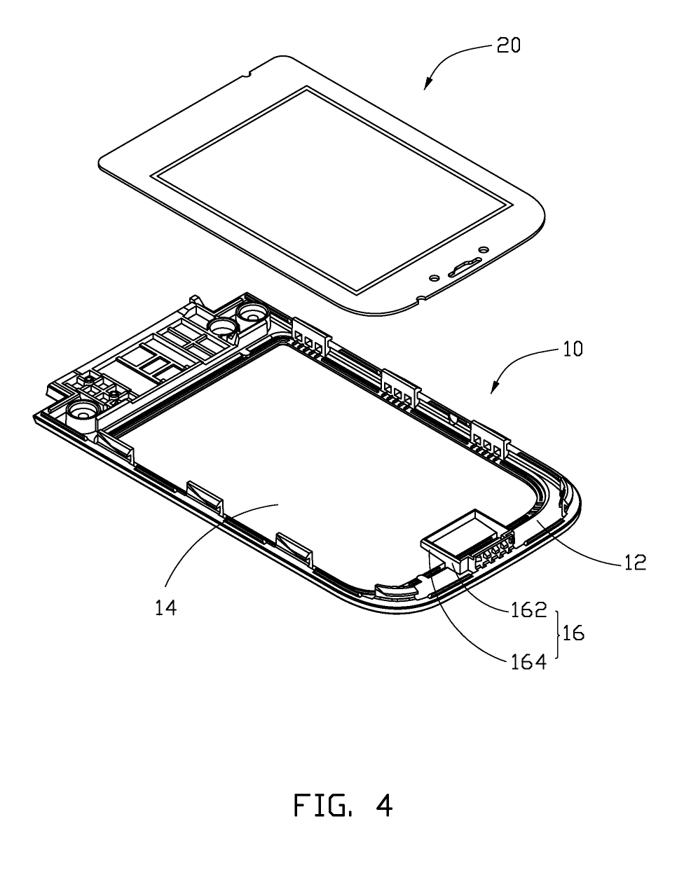

Referring to FIG. 2 and FIG. 4, the free part 164 has a surface 1640 facing the screen area 14. A wedge-shaped gap is defined between the surface 1640 and the screen area 14. The surface 1640 comprises a connecting end 1642 and a free end 1644 opposite to the connecting end 1642. The connecting end 1642 is contiguous with the connecting part 162. A distance between the connecting end 1642 and the screen area 14 is less than a distance between the free end 1644 and the screen area 14. In this embodiment, the surface 1640 is planar, and an angle is defined between the free part 164 and the screen area 14. In this embodiment, the angle is larger than 5 degrees.

One end of a lens 20 is inserted into the wedge-shaped gap from the free end 1644 along the surface 1640, and installed in the screen area 14. The angle between the end surface 1640 and the screen area is designed for installing the lens 20 easily and rapidly.

While various embodiments have been described, it should be understood that they have been presented by way of example only and not by way of limitation. The breadth and scope of the disclosure should not be limited by the described exemplary embodiments, but only in accordance with the following claims and their equivalents.

What is claimed is:

1. A mobile phone cover, comprising:
a frame, the frame defining a screen area therein; and
a holder being partially fixed on the frame and extending towards the screen area.

2. The mobile phone cover as claimed in claim 1, wherein the holder is integrally formed on the frame.

3. The mobile phone cover as claimed in claim 1, wherein the holder comprises a connecting part fixed on the frame and a free part extending from the connecting part towards the screen area.

4. The mobile phone cover as claimed in claim 3, wherein the free part and the screen area define an angle therebetween.

5. The mobile phone cover as claimed in claim 4, wherein the angle is larger than 5 degrees.

6. The mobile phone cover as claimed in claim 3, wherein a wedge-shaped gap is defined between a surface of the free part facing the screen area and the screen area.

7. A mobile phone, comprising:
a mobile phone cover comprising a frame and a holder, the frame defining a screen area therein, and the holder being partially fixed on the frame and extending towards the screen area.

8. The mobile phone as claimed in claim 7, wherein the holder is integrally formed on the frame.

9. The mobile phone as claimed in claim 7, wherein the holder comprises a connecting part fixed on the frame and a free part extending from the connecting part towards the screen area.

10. The mobile phone as claimed in claim 9, wherein the free part and the screen area define an angle therebetween.

11. The mobile phone as claimed in claim 10, wherein the angle is larger than 5 degrees.

12. The mobile phone as claimed in claim 9, wherein a wedge-shaped gap is defined between a surface of the free part facing the screen area and the screen area.
